(19) United States
(12) Patent Application Publication
(10) Pub. No.: US 2004/0001180 A1
(43) Pub. Date: Jan. 1, 2004

(54) Variable focus lens with internal refractive surface

(76) Inventor: Saul Epstein, Sherman Oaks, CA (US)

Correspondence Address: Saul Epstein, 14558 Deervale Place, Sherman Oaks, CA, 91403, US

(21) Appl. No.: 10/188,256

(22) Filed: Jul. 1, 2002

(51) Int. Cl. G02C 7/02; G02C 7/06; G02B 1/06; G02B 3/12

(52) U.S. Cl. 351/159; 359/665

(57) ABSTRACT

An improvement for liquid-filled variable focus lenses for eyeglasses. The invention is applicable to lenses of the type having a rigid lens, a distensible membrane, liquid filling the space between the rigid lens and the membrane, and some means for causing the liquid to press against and distend the membrane. The improvement comprises fabricating the rigid lens from material that has a substantially higher index of refraction than does the liquid filling, and shaping the rigid lens to provide an additional positive refractive surface. The positive optical power so provided reduces the required curvature on the exterior of the rigid lens so that this exterior curvature can be concave, even for hyperopic corrections.

### BACKGROUND OF THE INVENTION

This invention relates to liquid-filled variable focus lenses for use in spectacles. In broad terms, such a lens is comprised of a) a rigid lens, b) a transparent distensible or flexible membrane spaced from the rigid lens, c) a transparent liquid which fills the space between the rigid lens and the membrane, and d) some means for causing the liquid to press against the membrane so as to cause it to change curvature, thereby changing the optical power of the liquid surface bounded by the membrane. The means for causing the liquid to press against the membrane could, for example, be an external pump, as described, e.g., in U.S. Pat. No. 3,598,479, Wright, or, as another example, could be means for changing the spacing between the rigid lens and the membrane, as described, e.g., in U.S. Pat. No. 5,668,620, Kurtin et al. The membrane normally faces outward, away from the user, and the rigid lens faces the user's eyes.

In accordance with prior art practice, the rigid lens, the liquid, and the membrane, are selected so that their indices of refraction are as near to each other as is practical. Hence, even though a prior art liquid-filled variable focus lens is comprised of several physical elements, it functions as if it were a single homogeneous lens with a deformable surface. The optical characteristics of a prior art variable focus lens are therefore primarily determined by the shapes of its external surfaces, and the index of refraction of the materials from which it is constructed.

For a number of practical reasons, the optical power of the liquid surface bounded by the membrane (the “external liquid surface”) when the spectacles are set for distance viewing is typically made somewhat positive, commonly about +0.75 Diopters. Correspondingly, the external surface of the rigid lens is ground to the user's distance prescription, less the optical power of the external liquid surface at distance setting. If the user is sufficiently hyperopic to require a positive distance viewing correction greater than 0.75 Diopters, the external surface of the rigid lens will be convex. For reading, the optical power of the external liquid surface is varied upward from its distance value by the amount of the reading addition required by the user.

Unfortunately, a convex external rigid lens surface is not desirable. Reasons include: a) increased astigmatism at oblique incidence, b) difficulty in fining and polishing a convex surface, c) the possibility of eyelash interference, and d) sometimes troubling reflections. As a result, it is desirable that the external surface of the rigid lens be concave, for hyperopes—as well as for myopes. Even for myopes, it may be preferable that the external surface of the rigid lens have a greater concavity than usually obtains.

### SUMMARY OF THE INVENTION

The present invention permits the exterior surface of the rigid lens in a liquid-filled variable focus lens to be concave, even if the user is substantially hyperopic. This is accomplished by creating an additional positive refractive surface within the lens structure, i.e., a positive optical power is created at the surface between the rigid lens and the liquid. In most cases this technique eliminates the need for a positive external rigid lens surface.

Instead of fabricating the rigid lens from material having an index of refraction close to that of the liquid filling, as is done in the prior art, the rigid lens in the present invention is fabricated from a material having a substantial index mismatch with respect to the liquid. In order to provide a significant effect, the mismatch should be more than about 0.05. There are many material combinations that will result in an index mismatch exceeding 0.05; it is not difficult to find desirable materials having a mismatch in the range of 0.16, or even more. For example, a common lens filling liquid is Dow Corning silicone fluid DC 705, which has a refractive index of about 1.58, and lens materials having indexes as high as 1.74 are commonly available. One such a material is sold by Nikon Essilor under the trade name Presio i-Trend. The Presio i-Trend line of products by Nikon Essilor also includes a material having an index of refraction of 1.67, which would result in a 0.09 mismatch with Dow Corning 705 fluid. Even greater index mismatches can be achieved, if needed. For example, heavy flint glasses having an index of refraction of 1.89 are available. Pairing such a lens material with, for example, water (index=1.33) would result in a mismatch of 0.56. Many other pairs of materials offer useful refractive index mismatches.

If the rigid lens material has a higher index of refraction than the liquid, the desired positive internal refractive surface is achieved by putting a positive curvature on the surface of the rigid lens facing the liquid. In the event that the index mismatch is of the opposite sign, i.e., if the liquid has a higher index of refraction than the rigid lens, the curvature of the rigid lens would be made negative thereby achieving a positive optical power.

### BRIEF DESCRIPTION OF THE DRAWINGS

FIG. 1 is a head on view of the right lens of a pair of spectacles, looking in toward the face of the wearer.

FIG. 2 is a cross sectional view of the spectacle lens of FIG. 1, taken at 2-2 of FIG. 1. For clarity, the frame around the lens unit is not shown.

FIG. 3 is a detail view taken at 3-3 of FIG. 2.

FIG. 4 is a detail view taken at 4-4 of FIG. 2.

### DETAILED DESCRIPTION OF THE INVENTION

For purposes of explanation, the present invention is described in connection with a liquid-filled variable focus lens of the type disclosed in U.S. Pat. No. 5,668,620. Reference is made to that patent for a fuller explanation of the construction and operation of variable focus lenses of that type, and the disclosures therein are deemed included here by reference. It will, of course, be recognized by those skilled in the art that this invention is also applicable to most other types of liquid-filled variable focus lenses.

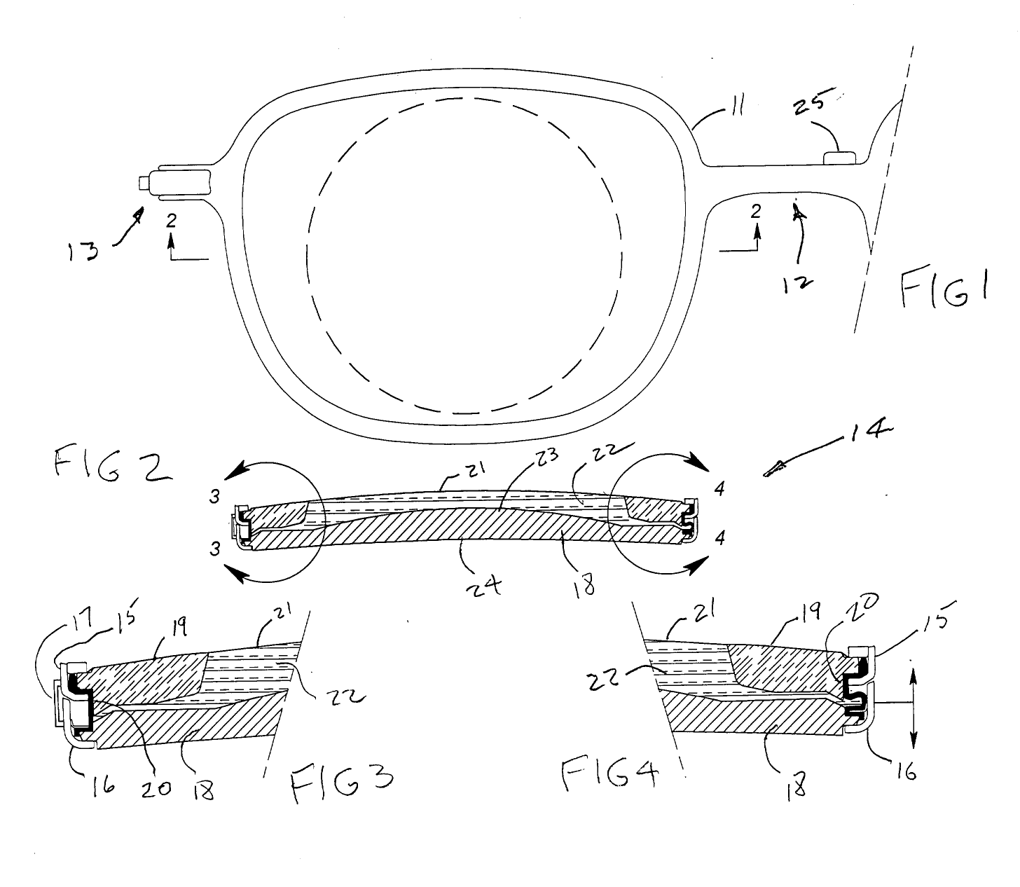

FIG. 1 of this application is a view of the right hand lens of a pair of spectacles according to the present invention, looking in toward the wearer. The terms “front” and “rear” (including their variants) will be used to refer to the directions away from and toward the wearer, respectively.

What is primarily visible in FIG. 1 is a cosmetic shell 11 that covers a lens unit 14 located behind it. The numeral 12 indicates the bridge of the spectacles, and the numeral 13 indicates a temple. FIG. 2 is a cross sectional view of the lens unit 14 that is located behind the shell 11 of FIG. 1. FIGS. 3 and 4 are enlarged detail views of portions of,the lens unit. The structural base of the lens unit is composed of two metallic rings that surround the lens unit, front ring 15 and rear ring 16. The rings 15 and 16 are attached at one point by leaf hinge 17, which constrains the relative motion between the rings to be angular.

The rear ring carries a rigid lens 18, whose function and construction will be described below, while the front ring carries a membrane support member 19 covered by a distensible membrane 21. The membrane support member 19 has a central, preferably circular, opening (indicated by the dashed line in FIG. 1).

A flexible seal 20 surrounds both the rigid lens and the membrane support, being attached with liquid-tight joints. The interior of the lens unit is filled with a liquid 22 having a predetermined index of refraction, the presently preferred liquid being Dow Corning 705 silicone fluid, which has an index of refraction of 1.58.

A mechanism within the bridge causes the region of the rear ring 16 opposite leaf hinge 17 to move relative to the front ring 15 as indicated by the arrows shown in FIG. 4 (responsive to displacement of slider 25 by the wearer). The mechanism is not illustrated. As the rear ring moves forward (illustrated as upward in FIG. 4), the liquid 22 will be pushed forward, and membrane 21 will be forced to bulge outward, increasing the optical power of the lens unit. If the rear ring is moved rearward, the opposite occurs.

If the index of refraction of the rigid lens 18 were substantially the same as that of the filling liquid 22, in accordance with prior art practice, the interface between the rigid lens and the liquid would have no optical significance, and the lens unit would function as single lens, the optical power of which is dictated by the shapes of its external surfaces and the index of refraction.

However, according to the present invention, the indices do not match. In accordance with the principles of the present invention, the rigid lens is fabricated from a material having an index of refraction significantly different from the index of refraction of the filling liquid 22, thereby creating an internal refractive surface. Index differences as low as 0.05 will provide a useful effect, but it is possible to find practical materials to achieve differences at least as high as 0.56 and possibly greater. For example, flint glasses are available having indexes of refraction as high as 1.89, and water has an index of 1.33.

The desired effect is achieved by using materials having significant index differences, and by forming a convex, preferably substantially spherical or aspherical, surface (23) on the front surface of the rigid lens 18 (i.e., at the interface between the rigid lens and the liquid filling). This surface contributes positive optical power, and thereby reduces the optical power required at the rear surface of the rigid lens.

As an example, consider a liquid-filled variable focus lens filled with Dow Corning DC 705 fluid (index of refraction=1.58), and a plastic rigid lens material having an index of refraction of 1.74. If a spherical radius of 2 inches is formed on the surface of rigid lens at the interface between it and the liquid, an effective lens surface having an optical power of about 3.15 Diopters will result. If the external liquid surface (when the lens unit is set to distance) has an optical power of 0.75 Diopters, the external surface of the rigid lens will be concave for all user distance prescriptions up to about 3.9 Diopters. A larger index mismatch and/or a smaller radius of the internal positive lens will result in the external surface of the rigid lens being concave with even higher positive distance prescriptions.

A particular embodiment of the invention has been described herein, however, it will be understood that while the described embodiment illustrates the principles of the invention, various modifications, additions, and/or deletions may be made thereto without departing from the spirit of the invention, the scope of which is defined by the following claims.

I claim:

1. In a liquid-filled variable focus lens of the type including a rigid lens, a distensible membrane spaced from said rigid lens, and liquid filling the space between said membrane and said rigid lens, the improvement wherein:
the index of refraction of said rigid lens and said distensible membrane differ by about 0.05 or more; and
the surface of said rigid lens in contact with said liquid is shaped to have a predetermined positive optical power when in contact with said liquid.

2. In a liquid-filled variable focus lens as recited in claim 1 wherein the surface of said rigid lens in contact with said liquid has a substantially spherical or aspherical shape.

3. In a liquid-filled variable focus lens as recited in claim 1 wherein said rigid lens has an index of refraction greater than the index of refraction of said liquid.

4. In a liquid-filled variable focus lens as recited in claim 3 wherein the surface of said rigid lens in contact with said liquid has a convex, substantially spherical or aspherical shape.

5. In a liquid-filled variable focus lens as recited in claim 1 wherein the index of refraction of said rigid lens is about 1.67 or higher, and the index of refraction of said liquid is about 1.58.

6. In a liquid-filled variable focus lens as recited in claim 1 wherein the index of refraction of said rigid lens is about 1.74, and the index of refraction of said liquid is about 1.58.

7. A liquid-filled variable focal length lens which comprises:
a rigid lens having a first index of refraction;
a transparent distensible membrane spaced from said rigid lens;
a transparent liquid having a second index of refraction filling the space between said rigid lens and said membrane, said second index of refraction being different from said first index of refraction by about 0.05 or more;
flexible sealing means for retaining said transparent liquid between said rigid lens and said membrane; and
variable spacing means acting between said rigid lens and said membrane for adjusting the spacing between said membrane and said rigid lens,
the surface of said rigid lens in contact with said liquid being shaped to have a predetermined positive optical power.

8. In a liquid-filled variable focus lens as recited in claim 7 wherein the surface of said rigid lens in contact with said liquid has a substantially spherical or aspherical shape.

9. In a liquid-filled variable focus lens as recited in claim 7 wherein said rigid lens has an index of refraction greater than the index of refraction of said liquid.

10. In a liquid-filled variable focus lens as recited in claim 9 wherein the surface of said rigid lens in contact with said liquid has a convex, substantially spherical or aspherical shape.

11. In a liquid-filled variable focus lens as recited in claim 7 wherein the index of refraction of said rigid lens is about 1.67 or higher, and the index of refraction of said liquid is about 1.58.

12. In a liquid-filled variable focus lens as recited in claim 7 wherein the index of refraction of said rigid lens is about 1.74, and the index of refraction of said liquid is about 1.58.
